(19) United States
(12) Patent Application Publication
(10) Pub. No.: US 2019/0305846 A1
(43) Pub. Date: Oct. 3, 2019

(54) RECEIVER, NON-TRANSITORY STORAGE MEDIUM, TRANSMITTER, LIGHTING APPARATUS, AND COMMUNICATIONS SYSTEM

(71) Applicant: Panasonic Intellectual Property Management Co., Ltd., Osaka (JP)

(72) Inventors: Shojiro KIDO, Osaka (JP); Teruhito TAKEDA, Hyogo (JP); Hiromichi GOTO, Osaka (JP); Kazuo ITOH, Osaka (JP); Hiroyuki NISHINO, Osaka (JP)

(21) Appl. No.: 16/356,237

(22) Filed: Mar. 18, 2019

(30) Foreign Application Priority Data
Mar. 29, 2018 (JP) 2018-063908

(51) Int. Cl. H04B 10/116; H04B 10/80; H04B 10/54

(52) U.S. Cl. CPC H04B 10/116; H04B 10/54; H04B 10/808

(57) ABSTRACT

Disclosed herein is a receiver including a receiver circuit, a control circuit, and a wireless communications circuit. The control circuit retrieves identification information and content information from a plurality of transmitters based on an output of the receiver circuit. The control circuit retrieves, when having failed to retrieve content information from the plurality of transmitters, identification information from at least two of the plurality of transmitters, identifies one of the at least two of the plurality of transmitters as a target transmitter in association with the retrieved identification information, and also identifies another one the at least two of the plurality of transmitters as a non-target transmitter in association with the retrieved identification information. The wireless communications circuit transmits the control signal to allow the target transmitter to transmit the second optical signal and cause the non-target transmitter not to transmit the second optical signal.

### CROSS-REFERENCE TO RELATED APPLICATION

This application claims the benefit of foreign priority to Japanese Patent Application No. 2018-063908 filed on Mar. 29, 2018, the entire contents of which are hereby incorporated by reference.

### TECHNICAL FIELD

The present disclosure generally relates to a receiver, a non-transitory storage medium, a transmitter, a lighting apparatus, and a communications system.

### BACKGROUND ART

An illumination system has been known in which a plurality of light fixtures with the ability to perform visible light communication with each other are arranged such that their irradiation ranges partially overlap with each other. For example, Japanese Unexamined Patent Application Publication No. 2016-225878 (hereinafter referred to as D1) discloses a technique for allowing a plurality of light fixtures to perform synchronized visible light communication even without a master device.

In the known illumination system, however, if a plurality of transmitters, e.g., (light fixtures in this case, are transmitting their respective optical signals independently of each other, then a receiver may receive optical signals from two or more transmitters simultaneously. This causes interference between the two or more optical signals in the receiver, thus sometimes causing a reception error that prevents the receiver from acquiring information from the optical signals properly.

### SUMMARY

The present disclosure provides a receiver, a non-transitory storage medium, a transmitter, a lighting apparatus, and a communications system, each of which allows information to be acquired from optical signals properly even when a plurality of transmitters are transmitting their respective optical signals independently of each other.

A receiver according to the present disclosure is designed for use in a space in which a plurality of transmitters, each configured to transmit a first optical signal and a second optical signal, are provided. The first optical signal contains identification information to identify one of the plurality of transmitters as a source transmitter. The second optical signal contains content information different from the identification information. The receiver includes a receiver circuit, a control circuit, and a communications circuit. The receiver circuit receives the first optical signal and the second optical signal from the plurality of transmitters. The control circuit retrieves the identification information and the content information from the plurality of transmitters based on an output of the receiver circuit. The communications circuit transmits a control signal for controlling respective operations of the plurality of transmitters. The control circuit retrieves, when having failed to retrieve content information from the plurality of transmitters, identification information from at least two of the plurality of transmitters, identifies one of the at least two of the plurality of transmitters as a target transmitter in association with the retrieved identification information, and also identifies another one of the at least two of the plurality of transmitters as a non-target transmitter in association with the retrieved identification information. The communications circuit is configured to transmit the control signal to allow the target transmitter to transmit the second optical signal and cause the non-target transmitter not to transmit the second optical signal.

A non-transitory storage medium according to the present disclosure stores a program to cause a computer to execute a function of a receiver for use in a space in which a plurality of transmitters, each configured to transmit a first optical signal and a second optical signal, are provided. The first optical signal contains identification information to identify one of the plurality of transmitters as a source transmitter. The second optical signal contains content information different from the identification information. The program includes a reception function, a control function, and a transmission function. The reception function includes receiving the first optical signal and the second optical signal. The control function includes retrieving the identification information and the content information based on a received result in the reception function. The transmission function includes transmitting a control signal for controlling respective operations of the plurality of transmitters. The control function includes: retrieving, when having failed to retrieve the content information, identification information; identifying one of the plurality of transmitters as a target transmitter, the one of the plurality of transmitters being associated with one of the identification information; and identifying another one of the plurality of transmitters as a non-target transmitter. The another one of the plurality of transmitters is associated with another one of the identification information. The transmission function includes transmitting the control signal to allow the target transmitter to transmit the second optical signal and to cause the non-target transmitter not to transmit the second optical signal.

A transmitter according to the present disclosure is provided with identification information assigned thereto. The transmitter includes: a light source; a driver circuit to cause the light source to transmit a first optical signal and a second optical signal by controlling optical power of the light source; and a communications circuit to receive a control signal for controlling the driver circuit. The first optical signal contains the identification information. The second optical signal contains content information different from the identification information.

A lighting apparatus according to the present disclosure includes the transmitter described above; and a housing to support the transmitter.

A communications system according to the present disclosure includes: the receiver described above; and a plurality of transmitters. Each of the plurality of transmitters includes a light source, a driver circuit, and a communications circuit. The driver circuit causes the light source to transmit the first optical signal and the second optical signal by controlling optical power of the light source. The communications circuit receives the control signal for controlling the driver circuit.

Another communications system according to the present disclosure includes: the receiver described above; a plurality of transmitters; and a center unit to communicate with the receiver and the plurality of transmitters. Each of the plurality of transmitters includes a light source, a driver circuit, and a communications circuit. The driver circuit causes the light source to transmit the first optical signal and the second optical signal by controlling optical power of the light source. The communications circuit receives the control signal for controlling the driver circuit. The receiver transmits, to the center unit, the signal to which location information indicating a location of the receiver is added. The center unit transmits, based on the location information, an instruction signal, instructing transmission of the first optical signal, to at least one of the plurality of transmitters. The at least one of the plurality of transmitters that has received the instruction signal transmits the first optical signal.

Still another communications system according to the present disclosure includes the receiver described above and a plurality of transmitters. Each of the plurality of transmitters includes a light source, a driver circuit, and a communications circuit. The light source includes multiple types of solid-state light-emitting elements to emit light with different wavelengths. The driver circuit causes the light source to transmit the first optical signal and the second optical signal by controlling optical power of one of the multiple types of solid-state light-emitting elements. The communications circuit receives the control signal for controlling the driver circuit. In at least two transmitters adjacent to each other among the plurality of transmitters, the solid-state light-emitting elements whose the optical power is controlled have different types from each other.

### BRIEF DESCRIPTION OF DRAWINGS

The figures depict one or more implementations in accordance with the present teachings, by way of example only, not by way of limitations. In the figures, like reference numerals refer to the same or similar elements.

FIG. 1 is a block diagram of a communications system including a receiver according to an exemplary embodiment;

FIG. 2 is a block diagram of a light fixture included in the communications system;

FIG. 3 illustrates transmission areas in the communications system;

FIG. 4 is a sequence chart illustrating the procedure of communication control to be performed when the communications system has started communications;

FIG. 5A is a plan view illustrating a situation surrounding an illumination space in the communications system;

FIG. 5B shows an image captured by the communications system;

FIG. 6A is a plan view illustrating another situation surrounding the illumination space in the communications system;

FIG. 6B shows another image captured by the communications system;

FIG. 7 is a sequence chart illustrating the procedure of communication control to be performed when interference has occurred in the communications system;

FIG. 8 is a sequence chart illustrating the procedure of communication control to be performed when a communication area is shifting in the communications system;

FIG. 9A is a cross-sectional view schematically illustrating a configuration for a light source for use in the communications system;

FIG. 9B is a cross-sectional view schematically illustrating a configuration for another light source for use in the communications system;

FIG. 10 is a block diagram illustrating another light fixture for use in the communications system;

FIG. 11 is a block diagram schematically illustrating still another light fixture for use in the communications system;

FIG. 12A is a cross-sectional view schematically illustrating a configuration for a light source of the light fixture shown in FIG. 11;

FIG. 12B is a cross-sectional view schematically illustrating a configuration for another light source; and

FIG. 13 is a cross-sectional view of a light fixture for use in the communications system.

### DESCRIPTION OF EMBODIMENTS

Embodiments of the present disclosure will be described with reference to the accompanying drawings.

The embodiments to be described below generally relate to a receiver, a non-transitory storage medium, a transmitter, a lighting apparatus, and a communications system, and more particularly relate to a receiver, a non-transitory storage medium, a transmitter, a lighting apparatus, and a communications system, all of which are configured or designed to receive or transmit identification information and content information.

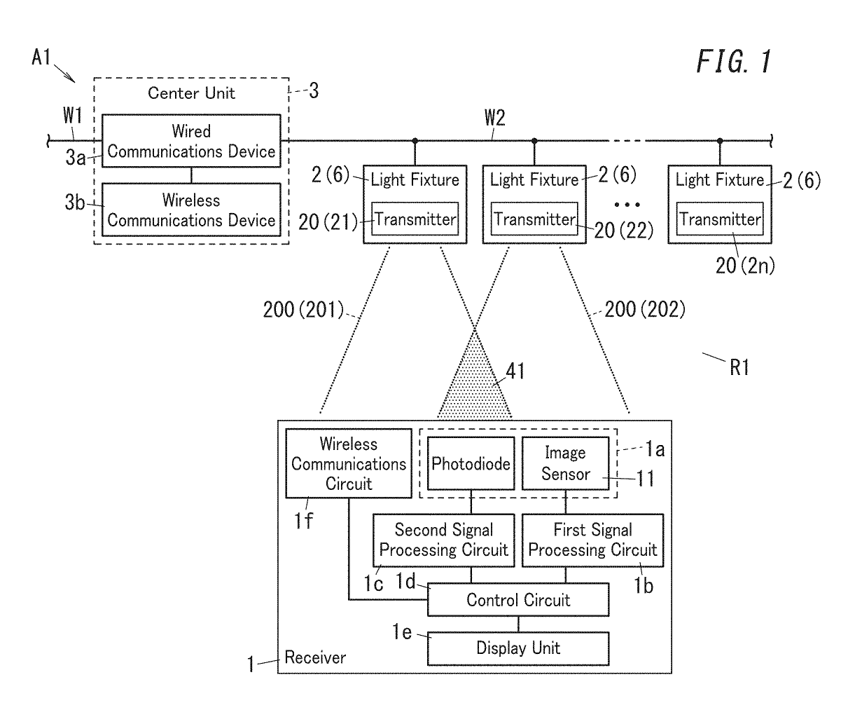

FIG. 1 illustrates an exemplary configuration for a communications system A1 according to an exemplary embodiment. The communications system A1 includes a receiver 1 to be carried by a user with him or her, a plurality of light fixtures 2, and a center unit 3, and may be provided in commercial facilities, stores, factories, warehouses, offices, and various other types of facilities. Each of the plurality of light fixtures 2 has its own preset transmission area. In other words, each of the plurality of light fixtures 2 transmits an optical signal to its own transmission area. The receiver 1 receives the optical signal and retrieves (i.e., demodulates) information from the optical signal. Note that the light fixtures 2 are exemplary lighting apparatuses 6 according to this embodiment.

The center unit 3 includes a wired communications device 3a and a wireless communications device 3b.

The wired communications device 3a receives content information such as video from an external device through a communications line W1 and transmits the content information to the plurality of light fixtures 2 through another communications line W2. As used herein, the “content information” refers to various sorts of information about the facility itself, or equipment, exhibits, merchandise, and other items in the facility, and represents some kind of content to be presented to the user in the forms of moving pictures, still pictures, animations, and other types of images or video. The communications lines W1 and W2 may each be a dedicated communications line or a local area network (LAN) cable, for example.

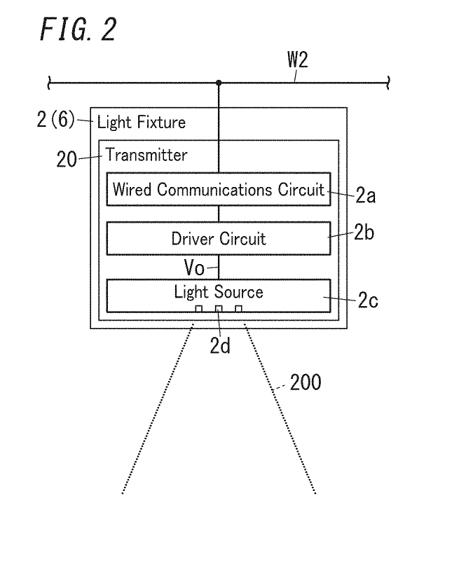

As shown in FIG. 2, each of the light fixtures 2 includes a transmitter 20, which includes a wired communications circuit 2a, a driver circuit 2b, and a light source 2c. The transmitter 20 emits illumination light in the facility and transmits an optical signal by superposing the optical signal on the illumination light.

The communications system A1 shown in FIG. 1 includes n (where n is a natural number equal to or greater than two) light fixtures 2 and n transmitters 20. In the following description, when it is necessary to distinguish the n transmitters 20, the n transmitters 20 will be designated herein by the reference signs 21, 22, . . . , and 2n, respectively.

The light source 2c includes a plurality of solid-state light-emitting elements. In this embodiment, the plurality of solid-state light-emitting elements are each implemented as a light-emitting diode (LED) 2d emitting visible light as illumination light. The LEDs 2d are connected together in series. The plurality of solid-state light-emitting elements that the light source 2c includes do not have to be LEDs 2d but may also be organic electroluminescent (OEL) devices, semiconductor laser diodes (LDs), or any other suitably type of light-emitting elements. Furthermore, the number of the solid-state light-emitting elements provided does not have to be plural but may also be single. In this embodiment, the plurality of solid-state light-emitting elements are electrically connected together in series. However, this is only an example and should not be construed as limiting. Alternatively, the plurality of solid-state light-emitting elements may also be electrically connected together in parallel. Still alternatively, the plurality of solid-state light-emitting elements may also be electrically connected together in combination of series and parallel.

The light source 2c is lit with DC power supplied from the driver circuit 2b to emit the illumination light. The plurality of light fixtures 2 each have their own preset irradiation area, and the light source 2c of each of the plurality of light fixtures 2 irradiates its associated irradiation area with the illumination light.

The wired communications circuit 2a has the capability of making wired communications with the wired communications device 3a through the communications line W1 and is able to receive the content information and an instruction signal from the wired communications device 3a. The wired communications circuit 2a passes the content information and instruction signal thus received to the driver circuit 2b.

Also, a unique identification (ID) is assigned in advance, as a kind of identification information, to each transmitter 20, and the driver circuit 2b stores the ID of its associated transmitter 20.

The driver circuit 2b is supplied with an input voltage by an external power supply such as a commercial power supply to convert the input voltage into a DC output voltage Vo and deliver the output voltage Vo. The driver circuit 2b performs constant current control such that a predetermined amount of DC current flows through the light source 2c. This allows the light source 2c to be lit with the DC current flowing to irradiate the irradiation area with the illumination light.

Furthermore, the driver circuit 2b modulates the output voltage Vo in accordance with the identification information and superposes a signal representing the identification information on the output voltage Vo. This allows the illumination light to contain the identification information. In addition, the driver circuit 2b modulates the output voltage Vo in accordance with the content information and superposes a signal representing the content information on the output voltage Vo. This allows the illumination light to contain the content information as well. That is to say, the illumination light includes both a first optical signal conveying the identification information and a second optical signal conveying the content information. A so-called “Light Fidelity (LiFi)” may be used as a technique for conveying information in the form of illumination light.

Suppose an area to which the optical signal is transmitted in the form of illumination light is the transmission area 200. If the illumination light is visible light, then the transmission area 200 generally corresponds with the irradiation area described above. In the following description, when it is necessary to distinguish the respective transmission areas 200 of the plurality of light fixtures 2 from each other, those transmission areas 200 will be designated herein by the reference signs 201, 202, 203, and so on.

In the following description of exemplary embodiments, a frequency at which the driver circuit 2b modulates the output voltage Vo in accordance with the identification information will be hereinafter referred to as a “first modulation frequency” and a frequency at which the driver circuit 2b modulates the output voltage Vo in accordance with the content information will be hereinafter referred to as a “second modulation frequency.” The second modulation frequency is higher than the first modulation frequency. For example, the first modulation frequency may be set at a frequency of 100 kHz or less, e.g., on the order of several ten kHz, while the second modulation frequency may be set at a frequency of a few hundred MHz. That is to say, the first optical signal conveying the identification information is an optical signal with a relatively low frequency, and the second optical signal conveying the content information is an optical signal with a relatively high frequency.

As shown in FIG. 1, the receiver 1 includes a receiver circuit 1a, a first signal processing circuit 1b, a second signal processing circuit 1c, a control circuit 1d, a display unit 1e, and a wireless communications circuit 1f. When currently located in any transmission area 200, the receiver 1 receives an optical signal from a light fixture 2 associated with the transmission area 200. In this embodiment, a smartphone, a tablet computer, or any other mobile telecommunications device carried by the user with him or her serves as the receiver 1.

The receiver circuit 1a suitably includes an image sensor 11 and a photodiode 12. The image sensor 11 may be a two-dimensional image sensor. For example, a complementary metal oxide semiconductor (CMOS) image sensor or a charge coupled device (CCD) image sensor may be used as the image sensor 11. The photodiode 12 has high-speed response characteristic and may be a PIN photodiode, for example.

In this embodiment, the image sensor 11 is provided for a camera included in the receiver 1. The image sensor 11 outputs, as a reception signal, an image capturing signal, which is an electrical signal containing information about an image representing the environment outside of the receiver 1 and captured through an optical member, such as a lens, arranged on the surface of the receiver 1. In the following description, such information will be hereinafter referred to as “captured image information.” The captured image is a color image, and a large number of photosensitive unit elements of the image sensor 11 are each configured to receive light with a particular wavelength through a color filter. In this embodiment, the respective photosensitive unit elements of the image sensor 11 each receive light with a red, green, or blue wavelength through a red, green, or blue color filter. Also, the receiver 1 suitably performs image capturing processing with the image sensor 11 by a rolling shutter method.

The photodiode 12 receives the illumination light emitted from the transmitter 20 through an optical member such as a lens arranged on the surface of the receiver 1 and outputs, as a reception signal, a light detection signal (electrical signal) containing information about the light intensity of the illumination light received.

The first signal processing circuit 1b receives the image capturing signal from the image sensor 11 and demodulates the image capturing signal received to generate captured image information. The second signal processing circuit 1c receives the light detection signal as an analog signal from the photodiode 12, converts it into a digital light detection signal through AD conversion processing, and outputs the digital light detection signal.

The control circuit 1d receives the captured image information from the first signal processing circuit 1b and retrieves identification information to identify the transmitter 20 based on the captured image information. The control circuit 1d also receives the light detection signal from the second signal processing circuit 1c and demodulates content information based on the light detection signal. Then, the control circuit 1d outputs the content information to the display unit 1e to have the content information displayed on the display unit 1e. Also, if the content information includes audio information, the control circuit 1d also outputs an audio signal representing the audio information to a loudspeaker or an earphone jack provided for the receiver 1. Furthermore, the control circuit 1d is also able to control transmission processing, such as starting and stopping transmitting an optical signal by each transmitter 20, by having a control signal transmitted from the wireless communications circuit 1f.

The display unit 1e may be implemented as a liquid crystal display or an organic EL display, for example, and corresponds to an information output unit according to this embodiment.

The wireless communications circuit if has the capability of communicating wirelessly with the wireless communications device 3b and corresponds to the communications circuit of the receiver 1. The wireless communications circuit if carries out wireless communications using radio waves (e.g., through a wireless LAN (local area network)) or an infrared ray.

The receiver 1 includes a computer system. The computer system may include, as principal hardware components, a processor and a memory. The functions of the first signal processing circuit 1b, the second signal processing circuit 1c, and control circuit 1d according to the present disclosure may be performed by making the processor execute a computer program for optical communication stored in a non-transitory storage medium such as the memory. The computer program for optical communication may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a largescale integrated circuit (LSI). Those electronic circuits may be either integrated together on a single chip or distributed on multiple chips without limitation. Those multiple chips may be integrated together in a single device or distributed in multiple devices without limitation.

When the computer system executes a computer program for optical communication, the receiver 1 performs the processing of receiving the optical signals such as the first optical signal and the second optical signal. The receiver 1 is implemented as a combination of respective functions of a computer system, a camera, and a photodiode provided for a smartphone or a tablet computer. In the following description, a computer program for optical communication will be hereinafter referred to as an “application for optical communication.”

Next, it will be described in detail how the communications system A1 performs the processing of transmitting and receiving the identification information and the content information.

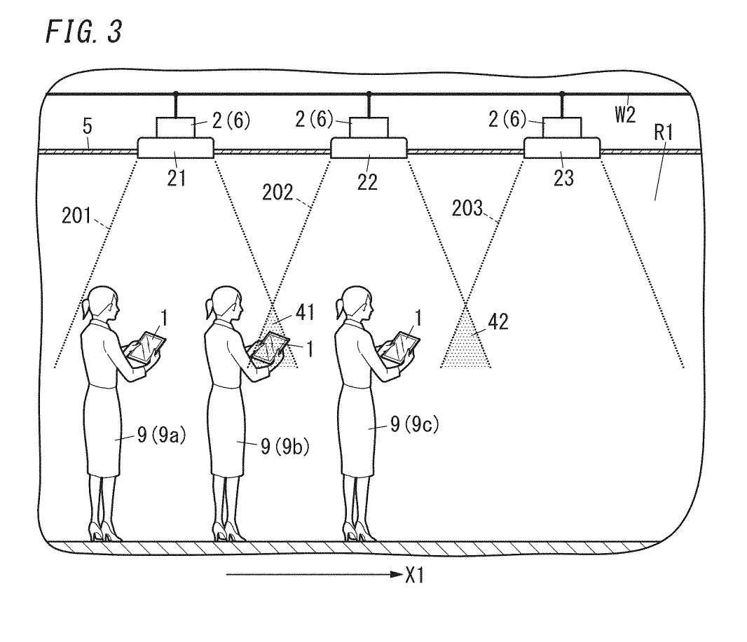

In FIG. 3, three light fixtures 2 are arranged side by side on a ceiling panel 5 of an illumination space R1 to illuminate the illumination space R1 under the ceiling panel 5. The three light fixtures 2 include transmitters 21, 22, and 23, respectively. These transmitters 21, 22, and 23 have their own transmission areas 201, 202, and 203, respectively. The transmitters 21, 22, and 23 are arranged in this order in a direction Xl, so are their corresponding transmission areas 201, 202, and 203. In FIG. 3, an area in which the transmission areas 201 and 202 overlap with each other is an “overlapping area 41” and an area in which the transmission areas 202 and 203 overlap with each other is an “overlapping area 42.”

In the example illustrated in FIG. 3, a user 9 carrying the receiver 1 with her moves through the illumination space R1. In FIG. 3, the user 9 moving is designated by three different reference signs 9a, 9b, and 9c, depending on her location.

Suppose a first situation where the user 9a is located below the transmitter 21 and the receiver 1 is located right under the transmitter 21. In that situation, the receiver 1 is located within the transmitter's 21 transmission area 201 and the user 9a is holding the receiver 1 such that the display unit 1e and the receiver circuit 1a face upward. At this point in time, none of the transmitters 21, 22, and 23 are transmitting the first optical signal containing identification information or the second optical signal containing the content information yet.

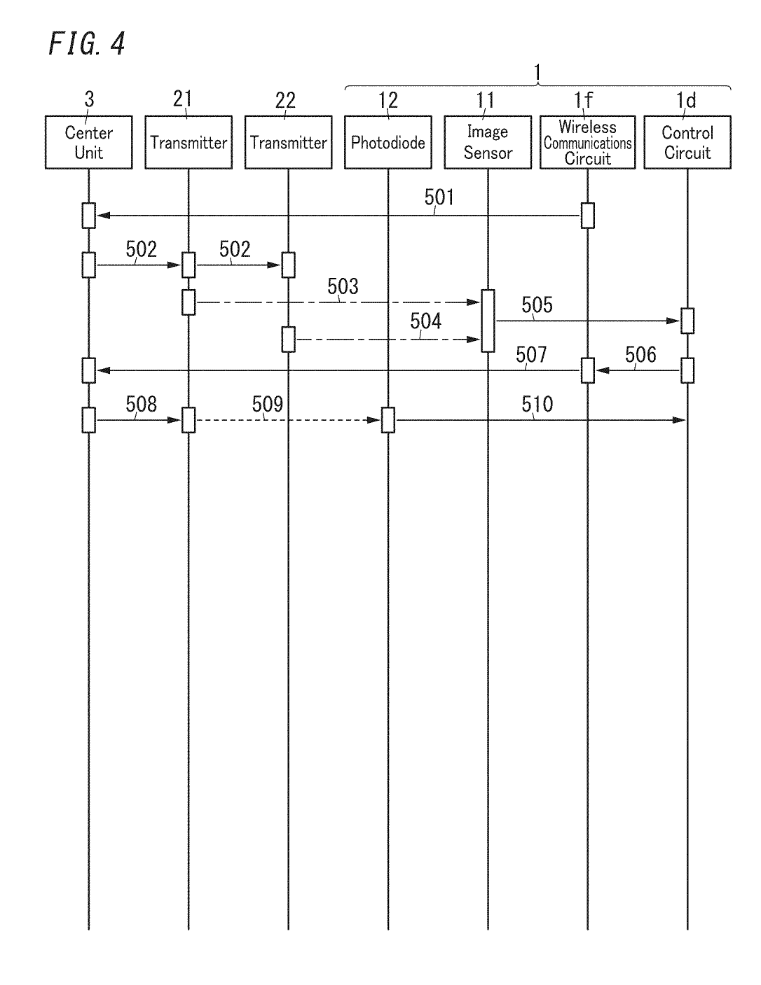

FIG. 4 shows a sequence of communications with the user 9a.

When the receiver 1 starts performing the optical communication application, the receiver circuit 1a starts a reception operation, and the image sensor 11 outputs an image capturing signal and the photodiode 12 outputs a light detection signal. At this point in time, none of the transmitters 21, 22, and 23 are transmitting the first optical signal or the second optical signal yet. Thus, the control circuit 1d is still unable to demodulate content information based on any light detection signal, i.e., light detection signal of the photodiode 12 in this case, supplied from the second signal processing circuit 1c, and therefore, requests transmitters 20 present around the receiver 1 to transmit their IDs as their identification information. The control circuit 1d stores in advance the map information, including information about the shape of the illumination space R1 and the locations of markers arranged in the illumination space R1, of the illumination space R1, and collates the captured image information with the map information to locate the receiver 1 in the illumination space R1. The control circuit 1d has an ID transmission request 501, to which location information indicating the location of the receiver 1 is added, transmitted from the wireless communications circuit 1f. The ID transmission request 501 corresponds to the control signal according to this embodiment.

In the center unit 3, the wireless communications device 3b receives the ID transmission request 501 and passes the ID transmission request 501 to the wired communications device 3a. The wired communications device 3a stores in advance the map information, and transmits, in accordance with the location information included in the ID transmission request 501, an ID instruction signal 502, instructing transmission of the ID, to the transmitters 20 present around the receiver 1. In this example, the ID instruction signal 502 is transmitted to each of the transmitters 21 and 22.

The transmitter 21 transmits a first optical signal 503 with the transmitter's 21 ID, and the transmitter 22 transmits a first optical signal 504 with the transmitter's 22 ID. The first signal processing circuit 1b receives an image capturing signal 505 from the image sensor 11, and demodulates the image capturing signal thus received to generate captured image information.

At this point in time, the receiver 1 is currently located right under the transmitter 21, and the transmitter 22 is located adjacent to the transmitter 21. The image captured by the image sensor 11 has shot not only the light fixture 2 including the transmitter 21 but also the light fixture 2 including the transmitter 22 as well. In other words, not only the illumination light emitted from the light source 2c of the transmitter 21 but also the illumination light emitted from the light source 2c of the transmitter 22 are incident on the image sensor 11. Then, the control circuit 1d receives the captured image information from the first signal processing circuit lb and is able to retrieve the transmitters' 21 and 22 IDs based on the captured image information. For example, the control circuit 1d may regard an area, having a local maximum luminance, of the captured image as an area where the light source 2c is present and may retrieve the IDs of the transmitters 20 based on a variation in the luminance values of pixels in the area where the light source 2c is present.

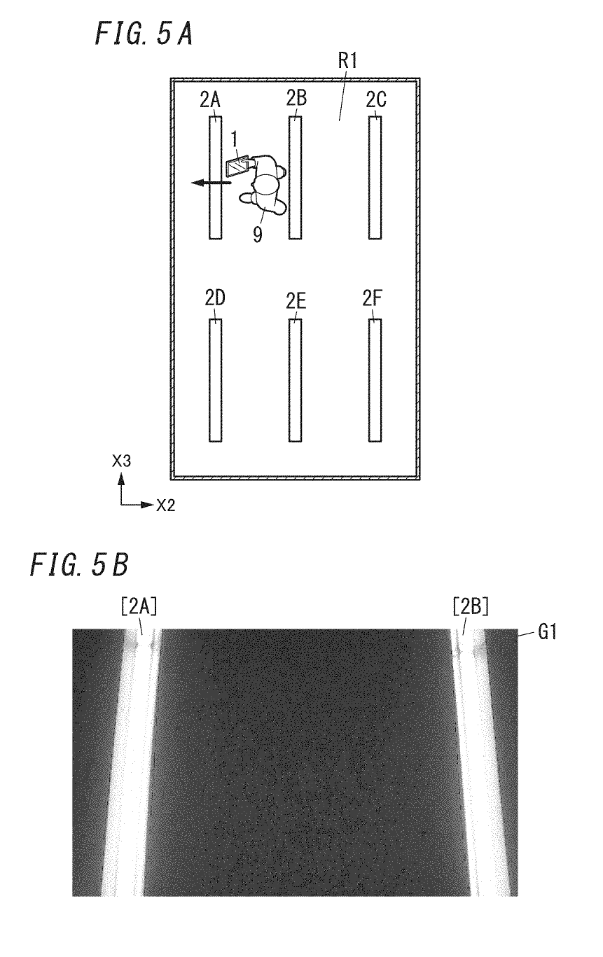

Suppose a row of illuminators, including light fixtures 2A, 2B, and 2C arranged in the direction X2, and another row of illuminators, including light fixtures 2D, 2E, and 2F also arranged in the direction X2, are arranged in the direction X3 as shown in FIG. 5A. In this case, these two directions X2 and X3 are perpendicular to each other. Furthermore, in FIG. 5A, the receiver 1 is currently located between the light fixtures 2A and 2B. When the image sensor 11 captures an image of a space over itself, a captured image G1 shown in FIG. 5B is generated, which includes an image capturing area [2A] of the light fixture 2A and an image capturing area [2B] of the light fixture 2B. In that case, the control circuit 1d regards each of the image capturing areas [2A] and [2B], having a local maximum luminance in the captured image G1, as an area where the light source 2c is present. This allows the control circuit 1d to retrieve the IDs of the respective transmitters 20 of the light fixtures 2A and 2B based on a variation in the luminance values of pixels in the image capturing areas [2A] and [2B].

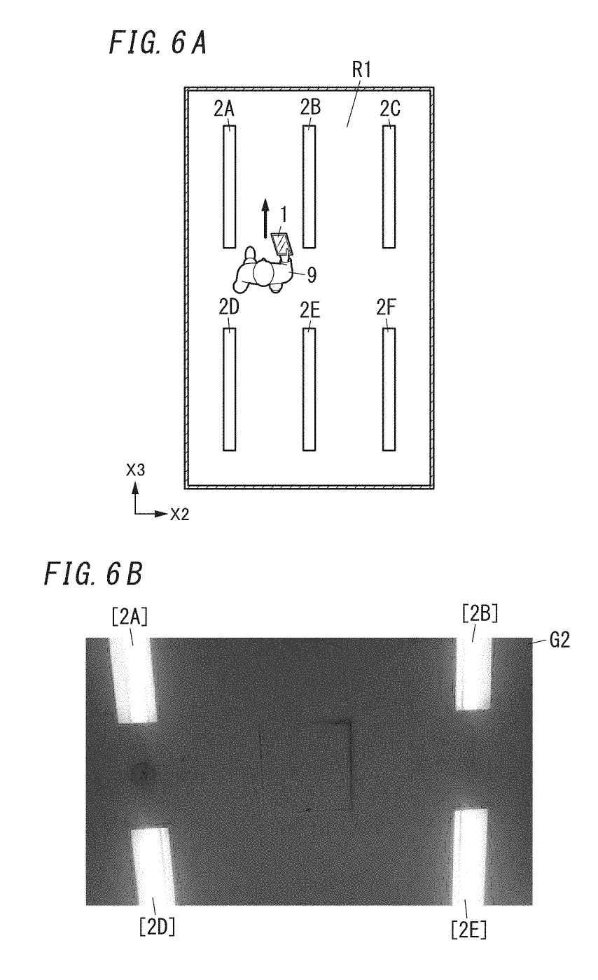

Meanwhile, suppose the receiver 1 is currently located between the light fixtures 2A, 2B, 2D, and 2E in FIG. 6A. When the image sensor 11 captures an image of a space over itself, a captured image G2 shown in FIG. 6B is generated, which includes an image capturing area [2A] of the light fixture 2A, an image capturing area [2B] of the light fixture 2B, an image capturing area [2D] of the light fixture 2D, and an image capturing area [2E] of the light fixture 2E. In that case, the control circuit 1d regards each of the image capturing areas [2A], [2B], [2D], and [2E], having a local maximum luminance in the captured image G2, as an area where the light source 2c is present. This allows the control circuit 1d to retrieve the IDs of the respective transmitters 20 of the light fixtures 2A, 2B, 2D, and 2E based on a variation in the luminance values of pixels in the image capturing areas [2A], [2B], [2D], and [2E].

Then, in the sequence of communications shown in FIG. 4, the control circuit 1d chooses one of the two IDs of the transmitters 21 and 22. In this example, the control circuit ld chooses the ID of a transmitter, which is more advantageous to receive the second optical signal, out of the two transmitters 21 and 22. Specifically, if the control circuit 1d has received the first optical signals from a plurality of transmitters 20, the control circuit 1d chooses the ID associated with the first optical signal having the highest signal intensity, and identifies a transmitter 20 with the ID thus chosen as a target transmitter (i.e., a transmitter which is more advantageous to receive the second optical signal). In addition, the control circuit 1d also identifies the other transmitter 20 of the plurality of transmitters 20, which are source transmitters of the first optical signals received, as a non-target transmitter. The signal intensity may be represented as the average, or a peak value, of luminance values of pixels at a location where the light source 2c is present, which is supposed to be an area, having a local maximum luminance, of the image captured.

Furthermore, providing the receiver 1 with the image sensor 11 allows the control circuit 1d to determine the relative location of the receiver 1 with respect to the light fixture 2 or the transmitters 20 through image recognition processing. Therefore, if the first optical signals have been received from a plurality of transmitters 20, the control circuit 1d may presume, based on the relative locations of the receiver 1 with respect to the light fixtures 2, from which light fixture's 2 transmitter 20 the optical signal is receivable most easily. In that case, the control circuit 1d chooses, based on a result of presumption, the ID of the transmitter 20 from which the optical signal is receivable most easily. Furthermore, if the receiver 1 is implemented as a smartphone, a tablet computer, or any other mobile telecommunications device, the control circuit 1d may determine the direction of movement of the receiver 1 based on the output of an acceleration sensor built in the receiver 1. Thus, if the first optical signals have been received from a plurality of transmitters 20, the control circuit 1d may presume, based on the direction of movement determined, from which light fixture's 2 transmitter 20 the optical signal is receivable most easily.

In FIG. 4, the first optical signal 503 has higher reception intensity than the first optical signal 504, and therefore, the control circuit 1d selects the ID associated with the first optical signal 503 as the ID of the target transmitter. In that case, the control circuit 1d identifies the transmitter 21 associated with the first optical signal 503 as a target transmitter, and also identifies the transmitter 22 associated with the first optical signal 504 as a non-target transmitter. Then, the control circuit 1d gives an instruction 506 to the wireless communications circuit if to transmit a content transmission request. Specifically, the control circuit 1d gives the transmission instruction 506 so as to allow the transmitter 21 as the target transmitter to transmit the second optical signal and prevent the transmitter 22 as the non-target transmitter from transmitting the second optical signal.

In response, the wireless communications circuit if transmits a content transmission request 507. The content transmission request 507 requests the transmitter 21, which is a target transmitter identified by the ID associated with the first optical signal 503, to transmit content information. Meanwhile, the content transmission request 507 does not request the transmitter 22, which is a non-target transmitter, to transmit content information. Note that the content transmission request 507 corresponds to the control signal according to this embodiment.

In the center unit 3, the wireless communications device 3b receives the content transmission request 507 and passes the content transmission request 507 to the wired communications device 3a. The wired communications device 3a transmits a content instruction signal 508, instructing transmission of content information, to the transmitter 21 identified by the ID specified by the content transmission request 507. On receiving the content instruction signal 508, the transmitter 21 transmits a second optical signal 509.

In the receiver 1, the photodiode 12 receives the second optical signal 509. The control circuit 1d receives a light detection signal 510 via the second signal processing circuit 1c and demodulates the content information. Then, the control circuit 1d outputs the content information to the display unit 1e to have the content information displayed on the display unit 1e.

Suppose a second situation where the user 9b, who is carrying the receiver 1 receiving content information from the transmitter 21, has entered the overlapping area 41 as shown in FIG. 3. Also, suppose, in such a situation, not only the transmitter 21 but also the transmitter 22 are transmitting a second optical signal to the transmission area 202. That is to say, in this second situation, the transmitters 21 and 22 are both transmitting content information, unlike in the first situation.

Now that the user 9b has entered the overlapping area 41, the receiver 1 is also located within the overlapping area 41. At this point in time, both the second optical signal transmitted from the transmitter 21 and the second optical signal transmitted from the transmitter 22 have reached the overlapping area 41. That is to say, the receiver 1 is able to receive both the second optical signal transmitted from the transmitter 21 and the second optical signal transmitted from the transmitter 22. This brings about interference in which the receiver 1 is receiving two second optical signals from two different source transmitters, respectively. This sometimes produces a reception error causing the control circuit 1d to fail to demodulate and acquire content information properly.

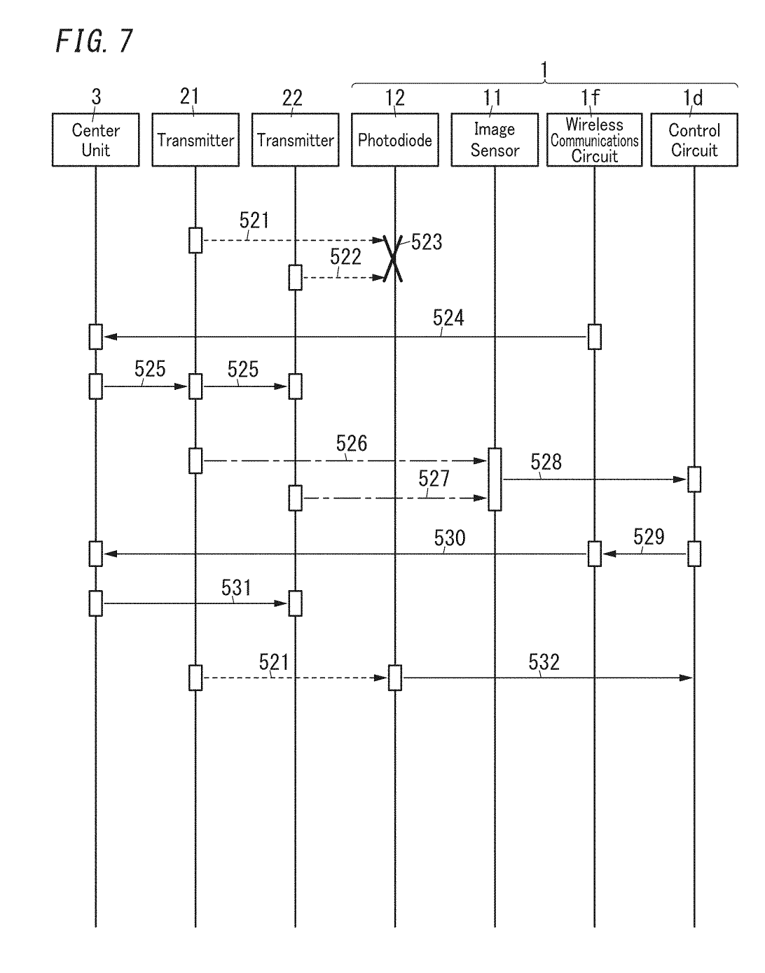

Thus, the communications system A1 carries out the sequence of communications shown in FIG. 7.

The transmitter 21 is transmitting a second optical signal 521 containing content information and the transmitter 22 is transmitting a second optical signal 522 also containing content information. When a reception error 523 that prevents the control circuit 1d from demodulating and acquiring the content information properly occurs in the control circuit 1d, the control circuit 1d has an ID transmission request 524, to which location information is added, transmitted from the wireless communications circuit 1f. The ID transmission request 524 corresponds to the control signal according to this embodiment.

In the center unit 3, the wireless communications device 3b receives the ID transmission request 524 and passes the ID transmission request 524 to the wired communications device 3a. The wired communications device 3a transmits an ID instruction signal 525, instructing transmission of the ID, to the transmitters 20 present around the receiver 1 in accordance with the location information included in the ID transmission request 524. In this example, the transmitters 21 and 22 are instructed to transmit their ID.

The transmitter 21 transmits a first optical signal 526 containing the transmitter's 21 ID, and the transmitter 22 transmits a first optical signal 527 containing the transmitter's 22 ID. The first signal processing circuit 1b receives an image capturing signal 528 from the image sensor 11 and demodulates the image capturing signal thus received to generate captured image information.

In this case, the image captured by the image sensor 11 has shot not only the light fixture 2 including the transmitter 21 but also the light fixture 2 including the transmitter 22 as well. In other words, not only the illumination light emitted from the light source 2c of the transmitter 21 but also the illumination light emitted from the light source 2c of the transmitter 22 are incident on the image sensor 11. Then, the control circuit 1d receives the captured image information from the first signal processing circuit 1b and is able to retrieve IDs of the transmitters 21 and 22 based on the captured image information.

Subsequently, the control circuit 1d allows the transmitter 20, which is a target transmitter identified by one of the two IDs of the transmitters 21 and 22, to continue transmitting the content information. In addition, the control circuit 1d makes the transmitter 20, which is a non-target transmitter identified by the other ID, stop transmitting the content information.

In FIG. 7, the first optical signal 526 has higher signal intensity than the first optical signal 527, and therefore, the control circuit 1d makes the transmitter 22 associated with the first optical signal 527 stop transmitting the content information. Specifically, the control circuit ld identifies the transmitter 21, of which the ID is associated with the first optical signal 526, as a target transmitter, and also identifies the transmitter 22, of which the ID is associated with the first optical signal 527, as a non-target transmitter. Then, the control circuit 1d gives an instruction 529 to transmit a content stop request, identifying the transmitter 22 as a non-target transmitter, to the wireless communications circuit 1f. In response, the wireless communications circuit 1f transmits the content stop request 530. The content stop request 530 requests the transmitter 22, which is a non-target transmitter whose ID is associated with the first optical signal 527, to stop transmitting the content information. The content stop request 530 corresponds to the control signal according to this embodiment.

In the center unit 3, the wireless communications device 3b receives the content stop request 530 and passes the content stop request 530 to the wired communications device 3a. The wired communications device 3a transmits a content instruction signal 531, instructing stop of transmission of the content information, to the transmitter 22 identified by the ID specified by the content stop request 530. On receiving the content instruction signal 531, the transmitter 22 stops transmitting the second optical signal 522.

From then on, the transmitter 21 continues transmitting the second optical signal 521, and in the receiver 1, the photodiode 12 receives the second optical signal 521. Now that the interference has already been resolved, the control circuit 1d is allowed to receive a light detection signal 532 via the second signal processing circuit 1c and demodulate the content information. Then, the control circuit 1d outputs the content information to the display unit 1e to have the content information displayed on the display unit 1e.

Suppose a third situation where the user 9c, who is carrying the receiver 1 receiving content information from the transmitter 21, has entered the transmission area 202. Now that the user 9c has entered the transmission area 202, the receiver 1 is also located within the transmission area 202. At this point in time, the second optical signal transmitted from the transmitter 21 does not reach the transmission area 202. In that case, the receiver 1 is no longer able to receive the second optical signal. This causes a reception error that prevents the control circuit 1d from demodulating and acquiring the content information properly.

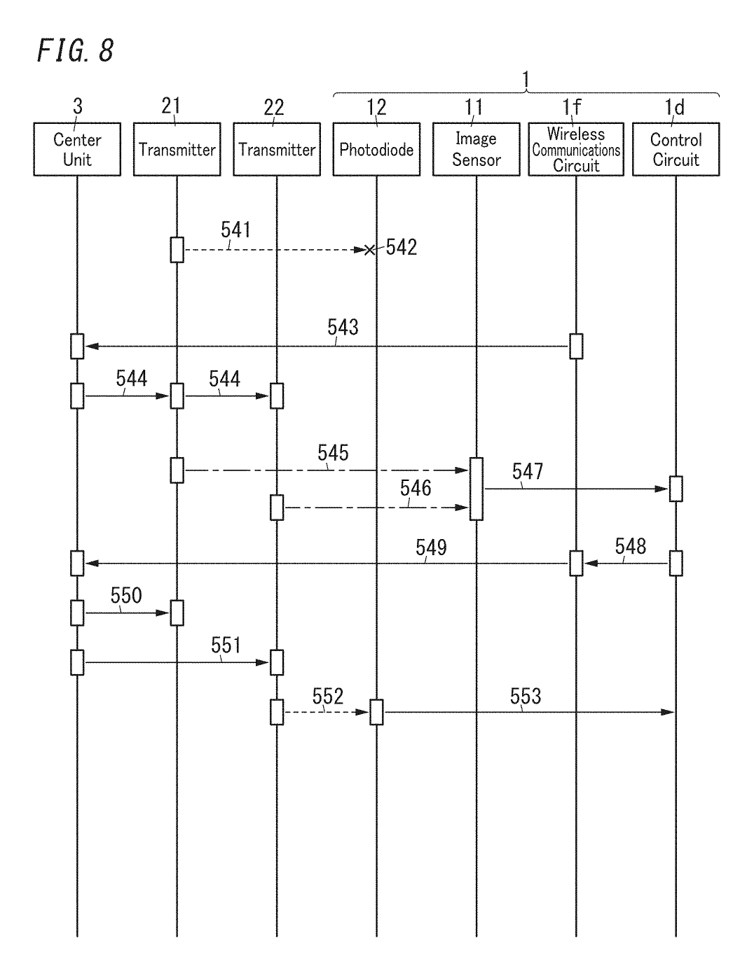

Thus, the communications system A1 carries out the sequence of communications shown in FIG. 8.

The transmitter 21 is transmitting a second optical signal 541 containing content information. When the receiver 1 moves to the transmission area 202, a reception error 542 that prevents the control circuit 1d from demodulating the content information properly (and acquiring the content information properly) occurs in the control circuit ld. Since the reception error 542 has occurred, the control circuit 1d has an ID transmission request 543, requesting transmission of an ID with location information, transmitted from the wireless communications circuit 1f. The ID transmission request 543 corresponds to the control signal according to this embodiment.

In the center unit 3, the wireless communications device 3b receives the ID transmission request 543 and passes the ID transmission request 543 to the wired communications device 3a. The wired communications device 3a transmits an ID instruction signal 544, instructing transmission of IDs, to the transmitters 20 present around the receiver 1 in accordance with the location information included in the ID transmission request 543. In this example, the transmitters 21 and 22 are instructed to transmit their ID.

The transmitter 21 transmits a first optical signal 545 containing the transmitter's 21 ID, and the transmitter 22 transmits a first optical signal 546 containing the transmitter's 22 ID. The first signal processing circuit 1b receives an image capturing signal 547 from the image sensor 11 and demodulates the image capturing signal thus received to generate captured image information.

In this case, the image captured by the image sensor 11 has shot not only the light fixture 2 including the transmitter 22 but also the light fixture 2 including the transmitter 21 as well. In other words, not only the illumination light emitted from the light source 2c of the transmitter 21 but also the illumination light emitted from the light source 2c of the transmitter 22 are incident on the image sensor 11. Then, the control circuit 1d receives the captured image information from the first signal processing circuit 1b and is able to retrieve the IDs of the transmitters 21 and 22 based on the captured image information.

In FIG. 8, the first optical signal 546 has higher signal intensity than the first optical signal 545, and therefore, the control circuit 1d makes the transmitter 22 associated with the first optical signal 546 start transmitting the content information and makes the transmitter 21 associated with the first optical signal 545 stop transmitting the content information. Specifically, the control circuit 1d identifies the transmitter 21, of which the ID is associated with the first optical signal 545, as a non-target transmitter, and also identifies the transmitter 22, of which the ID is associated with the first optical signal 546, as a target transmitter. Then, the control circuit 1d gives an instruction 548 to transmit a content transmission request, identifying the transmitter 22 as a target transmitter, and also transmit a content stop request, identifying the transmitter 21 as a non-target transmitter, to the wireless communications circuit 1f. In response, the wireless communications circuit 1f transmits a content control request 549. The content control request 549 requests the transmitter 22, which is a target transmitter whose ID is associated with the first optical signal 546, to transmit the content information. The content control request 549 also requests the transmitter 21, which is a non-target transmitter whose ID is associated with the first optical signal 545, to stop transmitting the content information. The content control request 549 corresponds to the control signal according to this embodiment.

In the center unit 3, the wireless communications device 3b receives the content control request 549 and passes the content control request 549 to the wired communications device 3a.

The wired communications device 3a transmits a content instruction signal 550, instructing stop of transmission of the content information, to the transmitter 21 identified by the ID specified by the content control request 549 to stop transmitting the content information. On receiving the content instruction signal 550, the transmitter 21 stops transmitting the second optical signal 541.

The wired communications device 3a also transmits a content instruction signal 551, instructing transmission of the content information, to the transmitter 22 identified by the ID specified by the content control request 549 to transmit the content information. On receiving the content instruction signal 551, the transmitter 22 starts transmitting the second optical signal 552 containing content information.

From then on, in the receiver 1, the photodiode 12 receives the second optical signal 552. The control circuit 1d is allowed to receive a light detection signal 553 via the second signal processing circuit 1c and demodulate the content information. Then, the control circuit 1d outputs the content information to the display unit 1e to have the content information displayed on the display unit 1e.

Optionally, the transmitters 20 may each periodically transmit the first optical signal containing identification information. In that case, there is no need for the receiver 1 to transmit the ID transmission request unlike the example described above, and each transmitter's 20 transmission operation, including starting and stopping transmitting the ID, may be controlled in accordance with the first optical signal transmitted periodically.

In the communications system A1 described above, each of the plurality of transmitters 20 has its transmission of content information in the form of the second optical signal controlled in accordance with an instruction from the receiver 1. In addition, the receiver 1 may select, from the plurality of transmitters 20, a transmitter 20 that facilitates acquisition of content information as a target transmitter, thus establishing a communication environment adapted to acquisition of the content information. This allows the receiver 1 to acquire information from the optical signal properly, even when the plurality of transmitters 20 are transmitting their respective optical signals independently of each other.

In addition, even if the receiver 1 is moving across the respective transmission areas 200 of the plurality of transmitters 20, the photodiode 12 is still allowed to continue the high-speed communication such as reception of the content information almost without a break.

In one comparative example, a time division method such as a multiple access method using random numbers or a synchronous method is used to transmit content information (hereinafter referred to as a “first comparative example”). The time division method rarely causes a reception error when the amount of information to transmit is small but may cause a reception error and content information may be acquired improperly when the amount of information to transmit is relatively large or when high-speed communication is carried out. Particularly when the content information is streaming data such as a moving picture, the moving picture played back by the receiver is sometimes interrupted.

In contrast, the communications system A1 described above does not employ the time division method, and therefore, reduces the chances of causing a reception error to prevent the content information from being acquired properly, even when the amount of information to transmit is relatively large or when high-speed communication is carried out.

In another comparative example, a technique has been proposed for relieving the congestion of radio wave bands to use by employing high-speed optical communication to download a lot of information and employing radio wave communications such as a wireless LAN to upload data of a small size (hereinafter referred to as a “second comparative example”). In that case, however, it is difficult for the receiver to determine which transmitter's transmission area the receiver itself is currently located. It is possible for the receiver to determine, using a beacon signal in the form of radio waves, which transmitter's transmission area the receiver itself is currently located. However, this technique does not allow the receiver to accurately determine which transmitter's transmission area the receiver itself is currently located.

In contrast, the communications system A1 described above allows the receiver 1 to retrieve the identification information of an available transmitter 20 based on the information about an image captured by the image sensor 11. This allows the communications system A1 to more accurately determine which transmitter's 20 transmission area 200 the receiver 1 is currently located, compared to the second comparative example.

Also, the receiver 1 suitably includes a three-axis acceleration sensor. In that case, the receiver 1 is able to determine, based on the output of the acceleration sensor, whether or not the receiver 1 itself is moving and, if the answer is YES, in which direction the receiver 1 is moving. Only when movement of the receiver 1 is detected, the image sensor 11 performs the operation of receiving the first optical signal. This allows the receiver 1 to reduce the power consumption of its built-in battery.

Furthermore, in the transmitter 20 of this embodiment, the driver circuit 2b sets a first modulation frequency, which is a frequency to modulate the identification information, at 100 kHz or less, e.g., on the order of several ten kHz, and also sets a second modulation frequency, which is a frequency to modulate the content information, at about a few hundred MHz. In that case, if the illumination light emitted from the light source 2c is white light, the light source 2c suitably emits illumination light that is white visible light using a combination of LEDs 2d emitting red, green, and blue rays (hereinafter referred to as “red, green, and blue LEDs”). Producing white illumination light through a combination of red, green, and blue LEDs allows the optical signal to have increased responsivity. Note that the red, green, and blue LEDs emit light rays in respective colors with different wavelengths.

Furthermore, when the light source 2c emits white illumination light using a combination of red, green, and blue LEDs as the plurality of LEDs 2d, a plurality of red LEDs forms a group of red LEDs, a plurality of green LEDs forms a group of green LEDs, and a plurality of blue LEDs forms a group of blue LEDs. In that case, the driver circuit 2b suitably applies respective output voltages (Vo) to the group of red LEDs, the group of green LEDs, and the group of blue LEDs independently of each other. Then, the driver circuit 2b superposes two signals containing identification information and content information, respectively, on the output voltage to be applied to only one group of LEDs in one of the three colors, among the group of red LEDs, the group of green LEDs, and the group of blue LEDs. That is to say, the driver circuit 2b makes the group of LEDs in any of the three colors transmit an optical signal.

The plurality of transmitters 20 includes a transmitter 20 transmitting the optical signal from the group of red LEDs, a transmitter 20 transmitting the optical signal from the group of green LEDs, and a transmitter 20 transmitting the optical signal from the group of blue LEDs. In that case, two adjacent ones of these three transmitters 20 suitably use two groups of LEDs emitting light rays in two different colors to transmit the optical signals. This configuration further reduces the chances of causing interference between the optical signals transmitted by two adjacent transmitters 20.

On the other hand, if each LED 2d is implemented as a white LED including an LED chip emitting blue light and a yellow phosphor and producing white illumination light as a combination of the blue LED chip and the yellow phosphor, then the optical signal causes a response delay while being transmitted through the yellow phosphor. Thus, the second modulation frequency will have an upper limit of approximately several MHz in that case.

Also, the light source 2c including a red LED, a green LED, and a blue LED as the plurality of LEDs 2d generally tends to have a relatively low color rendering index. Thus, providing the light source 2c with a red LED in addition to the combination of a blue LED chip and a yellow phosphor to compensate for the color red in the illumination light allows the color rendering index to be increased. In that case, the driver circuit 2b suitably superposes two signals respectively containing the identification information and the content information on only the output voltage applied to the group of red LEDs to make the group of red LEDs transmit the optical signal. In addition, providing a color filter that attenuates light, of which the wavelength is shorter than that of red light, for the photodiode 12 of the receiver 1 allows the optical signal reception performance to be maintained without decreasing the SNR.

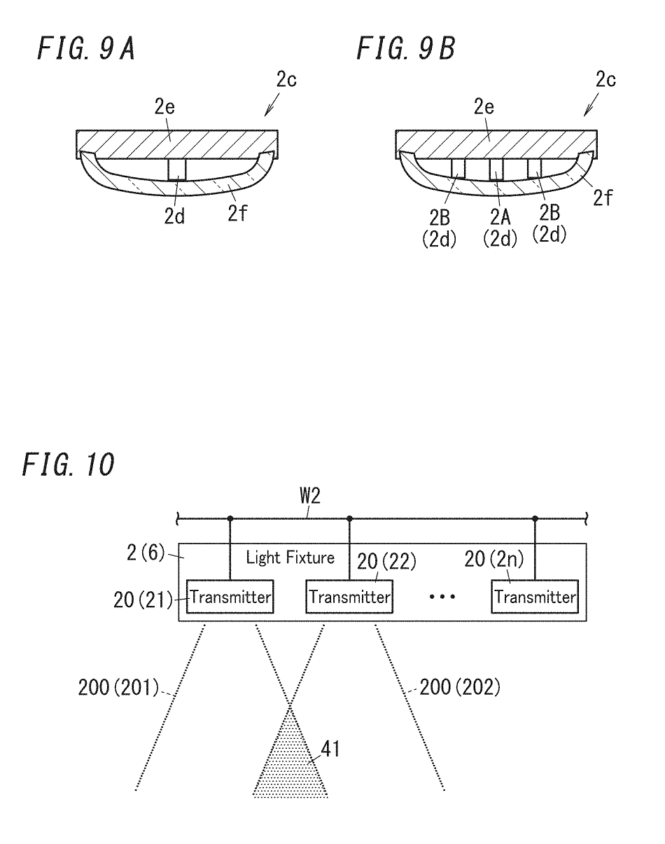

The light source 2c includes an LED 2d, a substrate 2e, and a lens 2f as shown in FIG. 9A. Note that although only one LED 2d is mounted on the substrate 2e in FIG. 9A for the safe of simplicity, a large number of LEDs 2d are actually mounted on the substrate 2e. The LED 2d is mounted on one surface of the substrate 2e to emit visible light such as white light. The lens 2f is attached to the one surface of the substrate 2e to cover the LED 2d. The visible light emitted from the LED 2d is transmitted through the lens 2f and radiated as illumination light. In that case, the optical signal is superposed on the visible light emitted from the LED 2d.

Optionally, the light source 2c may include, as the plurality of LEDs 2d, not only the white LED as the combination of a blue LED chip and a yellow phosphor but also an infrared LED emitting an infrared ray with a wavelength of 850 nm or 940 nm, for example. In that case, if the driver circuit 2b superposes the optical signal on the infrared ray, then the distribution range of the light emitted from the infrared LED, and eventually, the transmission area 200, may be broadened, because the optical signal hardly affects the visible light.

In addition, the light source 2c may include, as the plurality of LEDs 2d, not only the white LED as the combination of a blue LED chip and a yellow phosphor and the red LED but also an infrared LED emitting an infrared ray with a wavelength of 850 nm or 940 nm, for example. In that case, if the driver circuit 2b superposes the optical signal on the infrared ray, then the optical signal reception performance of the receiver 1 is improvable even in a low-illuminance illumination environment where the illuminance of the visible light is relatively low. This configuration is applicable particularly effectively to a situation where the communication rate of the optical signal should be increased in a low-illuminance illumination environment as in a theater, for example.

As described above, if the light source 2c includes, as the plurality of LEDs 2d, not only LEDs emitting visible light such as white light or red light (hereinafter referred to as “visible light LEDs”) but also an infrared LED, then the light source 2c may have the configuration shown in FIG. 9B, for example. The light source 2c includes a visible light LED 2X, infrared LEDs 2Y, a substrate 2e, and a lens 2f as shown in FIG. 9B. Note that although only one visible light LED 2X and two infrared LEDs 2Y are mounted on the substrate 2e in FIG. 9B for the safe of simplicity, a large number of visible light LEDs 2X and a large number of infrared LEDs 2Y are actually mounted on the substrate 2e. The visible light LED 2X is mounted on one surface of the substrate 2e to emit visible light such as white light or red light. The infrared LEDs 2Y are mounted on one surface of the substrate 2e to emit infrared light. The lens 2f is attached to the one surface of the substrate 2e to cover the visible light LED 2X and the infrared LEDs 2Y. The visible light emitted from the visible light LED 2X is transmitted through the lens 2f and radiated as illumination light. The optical signal is superposed on the infrared light emitted from the infrared LEDs 2Y, transmitted through the lens 2f, and sent as the optical signal.

Optionally, as shown in FIG. 10, the light fixture 2 may include a plurality of transmitters 20 including transmitters 21, 22, and so on. In that case, the plurality of transmitters 20 included in the single light fixture 2 have mutually different light distribution areas, and also have respectively different transmission areas 200 including transmission areas 201, 202, and so on. That is to say, the light distribution area of the single light fixture 2 is divided into a plurality of transmission areas 200, and the light fixture 2 transmits an optical signal to each of those transmission areas 200.

In FIG. 10, the single light fixture 2 has a plurality of transmission areas 200. That is to say, the plurality of transmission areas 200 are defined finely by the single light fixture 2.

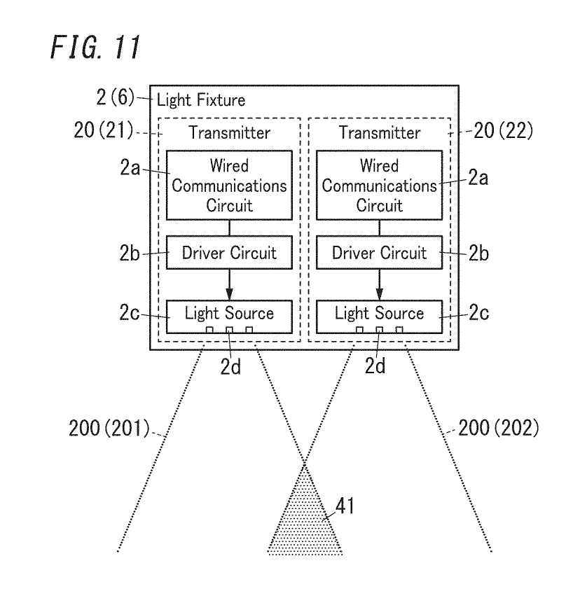

FIG. 11 illustrates a configuration for a light fixture 2 including two transmitters 20, namely, transmitters 21 and 22. The light fixture 2 shown in FIG. 11 includes two light sources 2c provided for the transmitters 21 and 22, respectively.

These two light sources 2c are formed by mounting their respective LEDs 2d and their respective lenses 2f on the same substrate 2e as shown in FIG. 12A. Note that although only one LED 2d is mounted on the substrate 2e for each light source 2c shown in FIG. 12A for the safe of simplicity, a large number of LEDs 2d are actually mounted on the substrate 2e for each light source 2c.

Also, if each of these two light sources 2c includes, as the plurality of LEDs 2d, not only a visible light LED emitting visible light such as white light or red light but also an infrared LED, then the two light sources 2c may have the configuration shown in FIG. 12B, for example. As shown in FIG. 12B, each of the two light sources 2c includes a visible light LED 2X, an infrared LED 2Y, a substrate 2e, and a lens 2f.

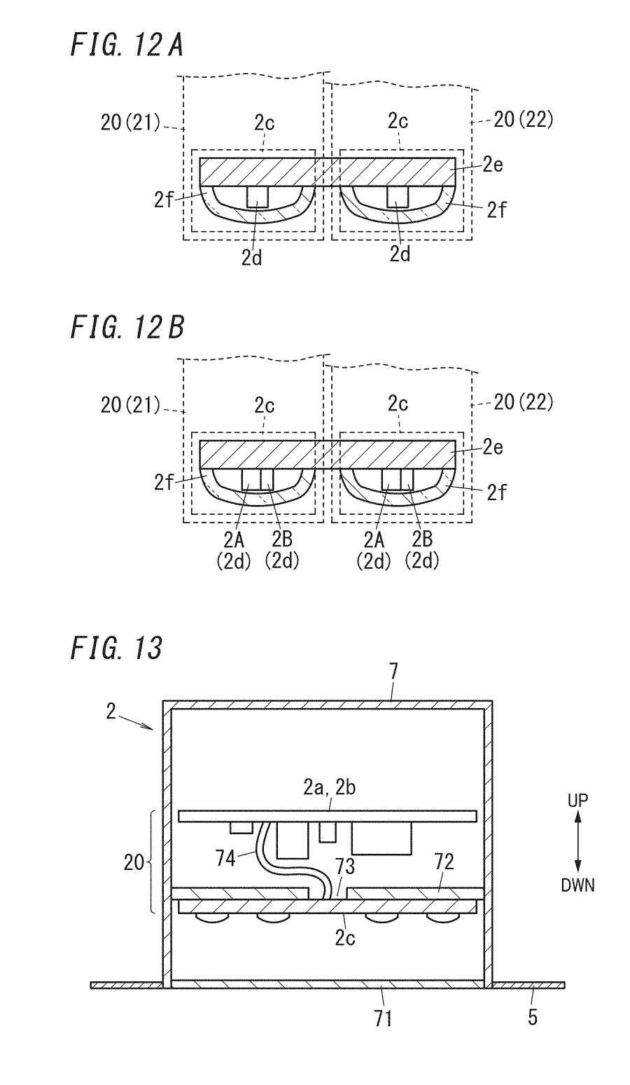

FIG. 13 illustrates, as an example of the light fixture 2, a down light to be embedded in a ceiling panel 5. The light fixture 2 includes the transmitter 20 described above, and a housing 7. The housing 7 may be made of a metallic material such as aluminum and formed in the shape of a bottomed cylinder with a closed top and a bottom opening. The bottom opening of the housing 7 is closed with a disk-shaped cover 71. The cover 71 is made of a light-transmitting material such as glass or polycarbonate. The space inside the housing 7 is divided by a disk-shaped partition plate 72 into an upper space and a lower space. On the upper surface of the partition plate 72, arranged are a wired communications circuit 2a and a driver circuit 2b. On the lower surface of the partition plate 72, arranged are light sources 2c. The driver circuit 2b is electrically connected to the light sources 2c via a power cable 74 passing through a cable hole 73 of the partition plate 72.

In the exemplary embodiments described above, the light fixture 2 has been described as an exemplary lighting apparatus 6. However, this is only an example and should not be construed as limiting. Alternatively, the lighting apparatus 6 may also be a digital signage or an infrared radiator, to name just a few.

As can be seen from the foregoing description, a receiver (1) according a first aspect of the exemplary embodiment is designed for use in a space (illumination space R1) in which a plurality of transmitters (20), each configured to transmit a first optical signal and a second optical signal, are provided. The first optical signal contains identification information to identify one of the plurality of transmitters (20) as a source transmitter. The second optical signal contains content information different from the identification information. The receiver (1) includes a receiver circuit (1a), a control circuit (1d), and a wireless communications circuit (1f) (communications circuit). The receiver circuit (1a) receives the first optical signal and the second optical signal from the plurality of transmitters (20). The control circuit (1d) retrieves the identification information and the content information from the plurality of transmitters (20) based on an output of the receiver circuit (1a). The wireless communications circuit (1f) transmits a control signal for controlling respective operations of the plurality of transmitters (20). The control circuit (1d) retrieves, when having failed to retrieve content information from the plurality of transmitters (20), identification information from at least two of the plurality of transmitters (20), identifies one of the at least two of the plurality of transmitters (20) as a target transmitter in association with the retrieved identification information, and also identifies another one of the at least two of the plurality of transmitters (20) as a non-target transmitter in association with the retrieved identification information. The wireless communications circuit (1f) allows the target transmitter to transmit the second optical signal and causes the non-target transmitter not to transmit the second optical signal.

This allows, even when two or more transmitters (20) are transmitting optical signals independently of each other, the receiver (1) to properly acquire information from the optical signals.

In a receiver (1) according to a second aspect of the exemplary embodiment, which may be implemented in conjunction with the first aspect, the receiver circuit (1a) includes: an image sensor (11) to receive the first optical signal; and a photodiode (12) configured to receive the second optical signal.

This allows the receiver (1) to receive identification information by low-speed optical communication using the first optical signal and to receive content information by high-speed optical communication using the second optical signal. Thus, this receiver (1) is able to receive even content information of a relatively large data size, such as a moving picture, normally by high-speed optical communication.

In a receiver (1) according to a third aspect of the exemplary embodiment, which may be implemented in conjunction with the second aspect, the control circuit (1d) identifies the target transmitter as the one of the at least two of the plurality of transmitters (20) from which the first optical signal having the greatest intensity is received.

This allows the receiver (1) to select one, facilitating acquisition of content information, of the plurality of transmitters (20) as the target transmitter, thus establishing a communication environment adapted to easy acquisition of content information.

In a receiver (1) according to a fourth aspect of the exemplary embodiment, which may be implemented in conjunction with the first aspect, the control circuit (1d) is configured to identify one of the plurality of transmitters (20) as the target transmitter according to a relative location between the receiver (1) and the plurality of transmitters (20) or a direction in which the receiver (1) is moved. The one of the plurality of transmitters is associated with any identification information.

In a receiver (1) according to a fifth aspect of the exemplary embodiment, which may be implemented in conjunction with any one of the first to fourth aspects, the wireless communications circuit (1f) transmits, when the control circuit (1d) has failed to retrieve the content information, the control signal for causing at least one of the plurality of transmitters (20) to transmit the first optical signal.

When the control circuit (1d) has failed to retrieve content information, the receiver (1) has the first optical signal transmitted by the at least one transmitter (20), thus allowing a transmitter (20), facilitating acquisition of the content information, to be selected as the target transmitter.

In a receiver (1) according to a sixth aspect of the exemplary embodiment, which may be implemented in conjunction with any one of the first to fifth aspects, the second optical signal has a higher frequency than the first optical signal.

A non-transitory storage medium according to a seventh aspect of the exemplary embodiment stores a program to cause a computer to execute a function of a receiver (1) for use in a space (illumination space R1) in which a plurality of transmitters (20), each configured to transmit a first optical signal and a second optical signal, are provided. The first optical signal contains identification information to identify one of the plurality of transmitters (20) as a source transmitter. The second optical signal contains content information different from the identification information. The program includes a reception function, a control function, and a transmission function. The reception function includes receiving the first optical signal and the second optical signal. The control function includes retrieving the identification information and the content information based on a received result in the reception function. The transmission function includes transmitting a control signal for controlling respective operations of the plurality of transmitters (20). The control function includes: retrieving, when having failed to retrieve the content information, identification information; identifying one of the plurality of transmitters (20) as a target transmitter, the one of the plurality of transmitters (20) being associated with one of the identification information; and identifying another one of the plurality of transmitters (20) as a non-target transmitter. The another one of the plurality of transmitters is associated with another one of the identification information. The transmission function includes transmitting the control signal to allow the target transmitter to transmit the second optical signal and cause the non-target transmitter not to transmit the second optical signal.

This allows, even when two or more transmitters (20) are transmitting optical signals independently of each other, a computer system, executing a computer program stored on a non-transitory storage medium, to properly acquire information from the optical signals.

A transmitter (20) according to an eighth aspect of the exemplary embodiment is provided with identification information assigned thereto. The transmitter (20) includes: a light source (2c); a driver circuit (2b) to cause the light source (2c) to transmit a first optical signal and a second optical signal by controlling optical power of the light source (2c); and a wired communications circuit (2a) (communications circuit) to receive a control signal for controlling the driver circuit (2b). The first optical signal contains the identification information. The second optical signal contains content information different from the identification information.

This enables the transmitter (20) to control, using a control signal, optical signal transmission processing, and therefore, allows, even when a plurality of transmitters (20) are transmitting optical signals independently of each other, the receiver (1) to acquire information from those optical signals properly.

In a transmitter (20) according to a ninth aspect of the exemplary embodiment, which may be implemented in conjunction with the eighth aspect, the light source (2c) includes multiple types of solid-state light-emitting elements to emit light with different wavelengths. The driver circuit (2b) has the first optical signal and the second optical signal transmitted from the light source (2c) by controlling optical power of one of the multiple types of solid-state light-emitting elements.

Thus, selecting appropriate types of solid-state light-emitting elements for transmitting the first optical signal and the second optical signal allows the transmitter (20) to increase its optical signal communication efficiency.

In a transmitter (20) according to a tenth aspect of the exemplary embodiment, which may be implemented in conjunction with the ninth aspect, the multiple types of solid-state light-emitting elements include a first solid-state light-emitting element to emit red light, a second solid-state light-emitting element to emit green light, and a third solid-state light-emitting element to emit blue light.

This allows the transmitter (20) to produce white light as a combination of the red light, green light, and blue light and also increase the responsivity of the optical signals.

A lighting apparatus (6) according to an eleventh aspect of the exemplary embodiment includes the transmitter (20) according to any one of the eighth to tenth aspects; and a housing (7) to support the transmitter (20).

This enables the lighting apparatus (6) to control optical signal transmission processing using a control signal, and therefore, allows, even when a plurality of transmitters (20) are transmitting optical signals independently of each other, the receiver (1) to acquire information from the optical signals properly.

A lighting apparatus (6) according to a twelfth aspect of the exemplary embodiment, which may be implemented in conjunction with the eleventh aspect, may include a plurality of the transmitters (20).

This allows a single lighting apparatus (6) to have a plurality of transmission areas (200), i.e., allows the single lighting apparatus (6) to define the plurality of transmission areas (200) finely.

A communications system (A1) according to a thirteenth aspect of the exemplary embodiment includes: the receiver (1) according to any one of the first to sixth aspects; and the plurality of transmitters (20) according to any one of the eighth to tenth aspects.

This allows, even when a plurality of transmitters (20) are transmitting optical signals independently of each other, the communications system (A1) to acquire information from the optical signals properly.

A communications system (A1) according to a fourteenth aspect of the exemplary embodiment includes: the receiver (1) according to the fifth aspect; a plurality of transmitters (20) according to any one of the eighth to tenth aspects; and a center unit (3) to communicate with the receiver (1) and the plurality of transmitters (20). The receiver (1) transmits, to the center unit (3), the control signal to which location information indicating a location of the receiver (1) is added. The center unit (3) transmits, based on the location information, an instruction signal, instructing transmission of the first optical signal, to at least one of the plurality of transmitters (20). The at least one of the plurality of transmitters (20) that has received the instruction signal transmits the first optical signal.

This allows, even when a plurality of transmitters (20) are transmitting optical signals independently of each other, the receiver (1) of the communications system (A1) to acquire information from the optical signals properly.

A communications system (A1) according to a fifteenth aspect of the exemplary embodiment includes the receiver (1) according to any one of the first to sixth aspects and a plurality of transmitters (20) according to the ninth or tenth aspect. The plurality of transmitters (20) includes at least two transmitters (29). In at least two transmitters (20) adjacent to each other among the plurality of transmitters (20), the solid-state light-emitting elements whose the optical power is controlled have different types from each other.

This reduces the chances of optical signals, transmitted by at least two adjacent transmitters (20), interfering with each other.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A receiver for use in a space in which a plurality of transmitters, each configured to transmit a first optical signal and a second optical signal, are provided,
the first optical signal containing identification information to identify one of the plurality of transmitters as a source transmitter, the second optical signal containing content information different from the identification information,
the receiver comprising:
a receiver circuit configured to receive the first optical signal and the second optical signal from the plurality of transmitters;
a control circuit configured to retrieve the identification information and the content information from the plurality of transmitters based on an output of the receiver circuit; and
a communications circuit configured to transmit a control signal for controlling respective operations of the plurality of transmitters,
wherein the control circuit is configured to, when having failed to retrieve content information from the plurality of transmitters, retrieve identification information from at least two of the plurality of transmitters, identify one of the at least two of the plurality of transmitters as a target transmitter in association with the retrieved identification information, and also identify another one of the at least two of the plurality of transmitters as a non-target transmitter in association with the retrieved identification information,
the communications circuit being configured to transmit the control signal to allow the target transmitter to transmit the second optical signal and cause the non-target transmitter not to transmit the second optical signal.

2. The receiver of claim 1, wherein
the receiver circuit includes: an image sensor configured to receive the first optical signal; and a photodiode configured to receive the second optical signal.

3. The receiver of claim 2, wherein
the control circuit is configured to identify the target transmitter as the one of the at least two of the plurality of transmitters from which the first optical signal having the greatest intensity is received.

4. The receiver of claim 1, wherein
the control circuit is configured to identify one of the plurality of transmitters as the target transmitter according to a relative location between the receiver and the plurality of transmitters or a direction in which the receiver is moved, the one of the plurality of transmitters being associated with any identification information.

5. The receiver of claim 1, wherein
the communications circuit is configured to, when the control circuit has failed to retrieve the content information, transmit the control signal for causing at least one of the plurality of transmitters to transmit the first optical signal.

6. The receiver of claim 1, wherein
the second optical signal has a higher frequency than the first optical signal.

7. A non-transitory storage medium storing a program to cause a computer to execute a function of a receiver for use in a space in which a plurality of transmitters, each configured to transmit a first optical signal and a second optical signal, are provided,
the first optical signal containing identification information to identify one of the plurality of transmitters as a source transmitter, the second optical signal containing content information different from the identification information,
the program comprising:
a reception function of receiving the first optical signal and the second optical signal;
a control function of retrieving the identification information and the content information based on a received result in the reception function; and
a transmission function of transmitting a control signal for controlling respective operations of the plurality of transmitters,
wherein the control function is configured to:
retrieve, when having failed to retrieve the content information, identification information;
identify one of the plurality of transmitters as a target transmitter, the one of the plurality of transmitters being associated with one of the identification information; and
identify another one of the plurality of transmitters as a non-target transmitter, the another one of the plurality of transmitters being associated with another one of the identification information, and
the transmission function is configured to transmit the control signal for causing the target transmitter to transmit the second optical signal and causing the non-target transmitter not to transmit the second optical signal.

8. A transmitter to which identification information is assigned, the transmitter comprising:
a light source;
a driver circuit configured to cause the light source to transmit a first optical signal and a second optical signal by controlling optical power of the light source; and
a communications circuit configured to receive a control signal for controlling the driver circuit,
wherein the first optical signal contains the identification information, and the second optical signal contains content information different from the identification information.

9. The transmitter of claim 8, wherein
the light source includes multiple types of solid-state light-emitting elements configured to emit light with different wavelengths, and
the driver circuit is configured to have the first optical signal and the second optical signal transmitted from the light source by controlling optical power of one of the multiple types of solid-state light-emitting elements.

10. The transmitter of claim 9, wherein
the multiple types of solid-state light-emitting elements include a first solid-state light-emitting element configured to emit red light, a second solid-state light-emitting element configured to emit green light, and a third solid-state light-emitting element configured to emit blue light.

11. Alighting apparatus comprising:
the transmitter of claim 8; and
a housing configured to support the transmitter.

12. The lighting apparatus of claim 11, wherein
the lighting apparatus comprises a plurality of the transmitters.

13. A communications system comprising:
the receiver of claim 1; and
a plurality of transmitters,
each of the plurality of transmitters including:
a light source;
a driver circuit configured to cause the light source to transmit the first optical signal and the second optical signal by controlling optical power of the light source; and
a communications circuit configured to receive the control signal for controlling the driver circuit.

14. A communications system comprising:
the receiver of claim 5;
a plurality of transmitters; and
a center unit configured to communicate with the receiver and the plurality of transmitters,
each of the plurality of transmitters including:
a light source;
a driver circuit configured to cause the light source to transmit the first optical signal and the second optical signal by controlling optical power of the light source; and
a communications circuit configured to receive the control signal for controlling the driver circuit,
wherein the receiver is configured to transmit, to the center unit, the signal to which location information indicating a location of the receiver is added,
the center unit is configured to transmit, based on the location information, an instruction signal, instructing transmission of the first optical signal, to at least one of the plurality of transmitters,
the at least one of the plurality of transmitters that has received the instruction signal is configured to transmit the first optical signal.

15. A communications system comprising:
the receiver of claim 1; and
a plurality of transmitters,
each of the plurality of transmitters including:
a light source including multiple types of solid-state light-emitting elements configured to emit light with different wavelengths;
a driver circuit configured to cause the light source to transmit the first optical signal and the second optical signal by controlling optical power of one of the multiple types of solid-state light-emitting elements; and
a communications circuit configured to receive the control signal for controlling the driver circuit,
wherein in at least two transmitters adjacent to each other among the plurality of transmitters, the solid-state light-emitting elements whose the optical power is controlled have different types from each other.
